(19) United States
(12) Patent Application Publication
(10) Pub. No.: US 2025/0358227 A1
(43) Pub. Date: Nov. 20, 2025

(54) SYSTEM AND METHOD FOR CELLULAR NETWORK BUSY HOUR TRAFFIC DETERMINATION

(71) Applicant: DISH Wireless L.L.C., Englewood, CO (US)

(72) Inventors: Ahmed Awwad Whdan, Centennial, CO (US); Satish Kumar Sharma, Denver, CO (US)

(21) Appl. No.: 18/669,094

(22) Filed: May 20, 2024

(51) Int. Cl. H04L 47/127; H04W 28/02

(52) U.S. Cl. CPC H04L 47/127; H04W 28/0289

(57) ABSTRACT

Systems and methods are directed towards determining busy hour traffic of nodes in a cellular network based on different traffic loads on the nodes. One or more nodes in the cellular network are selected to be monitored. The traffic load on the selected node is monitored during a time period. The monitored traffic load on the node during the time period is determined to be stable traffic or high variance traffic. In response to the monitored traffic load on the node being stable traffic, busy hour traffic is determined for the node based on an average peak traffic load on the node. In response to the monitored traffic load on the node being high variance traffic, the busy hour traffic for the node is determined based on an average median traffic load on the node. The busy hour traffic for the node can then be used to predict future traffic on the node.

### BACKGROUND

People are becoming more reliant on the speed, efficiency, and availability of cellular networks. Recently, one advancement in cellular network technology has been to move many of the network functions associated with managing wireless network communications to cloud computing resources, rather than dedicated servers. Accordingly, cloud computing resources are often dedicated for the cellular network. But dedication of such cloud computing resources can result in underutilized or overutilized resources depending on the overall use or load of the network. As a result, resources are wasted when underutilized and the cellular network can become slow or inefficient when overutilized. It is with respect to these and other considerations that the embodiments described herein have been made.

### BRIEF SUMMARY

Embodiments are directed to systems and methods for dynamically determining busy hour traffic of nodes in a cellular communications network using a mechanism that is selected based on different traffic loads on the nodes. The traffic load on one or more nodes in a cellular network are monitored for a time period. In general, the traffic load may be determined or identified as stable traffic or high variance traffic.

If the monitored traffic load on a node is determined to be stable traffic during the time period, then the busy hour traffic for the node is determined based on an average peak traffic load on the node. For example, the monitored traffic load is separated into plurality of daily time segments across the time period and a subset of daily time segments from the plurality of daily time segments having a highest traffic load are selected. The average peak traffic load for the node may be determined from an average of the traffic load from a selected subset of daily time segments. The selected subset of daily time segments may be identified as the busy hours for the node and the average peak traffic load may be the utilized as the busy hour traffic to predict future traffic on the node.

If the monitored traffic load on a node is determined to be high variance traffic during the time period, then the busy hour traffic for the node based on an average median traffic load on the node. For example, the monitored traffic load may be separated into plurality of daily time segments across the time period. A median traffic load is determined for each of the plurality of daily time segments and a subset of daily time segments from the plurality of daily time segments having a highest median traffic load are selected. The average median traffic load for the node is determined from an average of the median traffic load from the selected subset of daily time segments. The selected subset of daily time segments may be identified as the busy hours for the node and the average median traffic load may be the utilized as the busy hour traffic to predict future traffic on the node.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for dynamically determining busy hour traffic of a node in a cellular network using a mechanism selected based on the traffic load on the node in accordance with embodiments described herein;

FIG. 2 illustrates a logical flow diagram showing one embodiment of a process for dynamically determining busy hour traffic of a node in a cellular network using a mechanism selected based on the traffic load on the node in accordance with embodiments described herein;

FIG. 3 illustrates a logical flow diagram showing one embodiment of a process for dynamically determining busy hour traffic of a node in a cellular network based on the traffic load on the node being stable in accordance with embodiments described herein;

FIG. 4 illustrates a logical flow diagram showing one embodiment of a process for dynamically determining busy hour traffic of a node in a cellular network based on the traffic load on the node having high variability in accordance with embodiments described herein; and

FIG. 5 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, actions, or characteristics of the present disclosure, and are not limited to the same or different embodiments unless the context clearly dictates otherwise. Furthermore, the described features, structures, functions, limitations, actions, or characteristics may be combined in any suitable manner in accordance with this disclosure, and references to “in one embodiment,” “in another embodiment,” “in various embodiments,” “in some embodiments,” “in other embodiments,” etc., do not preclude the combination of the features, structures, functions, limitations, actions, or characteristics in any of the embodiments described herein. Accordingly, embodiments described herein can be combined in any combination unless the context clearly dictates otherwise.

As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

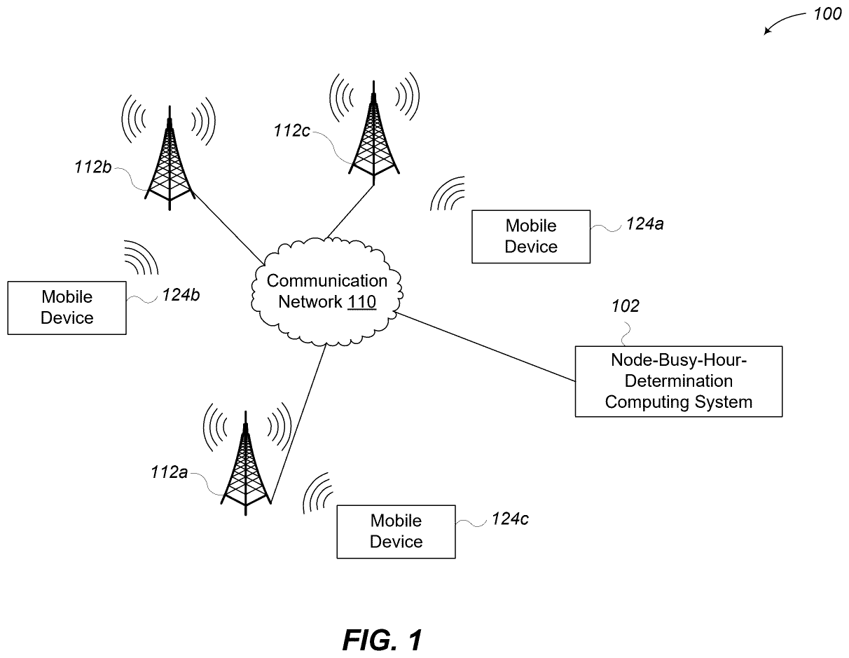

FIG. 1 illustrates a context diagram of an environment 100 for dynamically determining busy hour traffic of a node in a cellular network using a mechanism selected based on the traffic load on the node in accordance with embodiments described herein. Environment 100 includes a plurality of cell towers 112a-112c, a plurality of mobile devices 124a-124c, a node-busy-hour-determination computing system 102, and a communication network 110.

The cell towers 112a-112c are cellular towers that together provide the hardware infrastructure of a cellular communications network, e.g., a 5G cellular communications network. The cell towers 112a-112c may include or be in communication with base stations, radio back haul equipment, antennas, or other devices, which are not illustrated for ease of discussion. In various embodiments, the cell towers 112a-112c may communicate with each other via communication network 110. Communication network 110 includes one or more wired or wireless networks, which may include a series of smaller or private connected networks that carry information between the cell towers 112a-112c.

The mobile devices 124a-124c are computing devices that receive and transmit cellular communications with the cell towers 112a-112c. Mobile devices 124a-124c may be referred to as user devices, mobile computing devices, user mobile devices, user equipment, or other similar terminology. Examples of mobile devices 124a-124c may include, but are not limited to, mobile phones, smartphones, tablets, cellular-enabled laptop computers, or other computing devices that can communication with a cellular network.

The node-busy-hour-determination computing system 102 is a server, computing device, cloud computing environment, or some other computing system configured to monitor the traffic load on nodes of the cellular communications network to determine the busy hour traffic of each separate node. The node-busy-hour-determination computing system 102 utilizes the monitored traffic load on a node to determine which mechanism to employ to dynamically determine busy hour traffic for the node. For example, if the monitored traffic load on a node is stable traffic (or high-volume traffic), then the busy hour traffic for the node is determined based on an average peak traffic load on the node. But if the monitored traffic load on a node is high variance traffic (or low-volume traffic), then the busy hour traffic for the node is determined based on an average median traffic load on the node.

Nodes may include distributed units (DUs), central units (CUs), sectors, cells, radio units (RUs), or other components of the cellular communications network. Cells provide a defined frequency spectrum for a specific sector, where sectors are geographical areas (also referred to as coverage areas) serviced by the cellular communications network. RUs are configured to provide the antenna and radio functions for a cell to communication with user devices. DUs provide real-time support for lower layers of the protocol stack for cellular communications, such as the radio link control (RLC) layer and the medium access control (MAC) layer. CUs may provide support for higher layers of the protocol stack for cellular communications, such as the service data adaptation protocol (SDAP) layer, the packet data convergence control (PDCP) layer, and the radio resource control (RRC) layer. In some embodiments, the DUs and the CUs may be executed as virtual instances within a data center environment. Collectively, the RUs, the DUs, and the CUs provide the structural aspects for the cells of the network to facilitate communications between user devices and the network. In some embodiments, the cells may include the RUs, DUs, and CUs, that support a defined frequency spectrum for a specific sector.

Accordingly, the node-busy-hour-determination computing system 102 may employ embodiments described herein to determine the busy hour traffic for one or more DUs, one or more CUs, one or more sectors, one or more cells, one or more RUs, or some combination thereof. As a result, the node-busy-hour-determination computing system 102 can utilize these busy hours to predict the loads of one or more DUs, one or more CUs, one or more sectors, one or more cells, one or more RUs, or some combination thereof. Such predictions can then be used to increase or decrease (e.g., scale up or scale down) the number of DUs, the number of CUs, the number of sectors, the number of cells, the number of RUs, or some combination thereof. Further embodiments are described in more detail below.

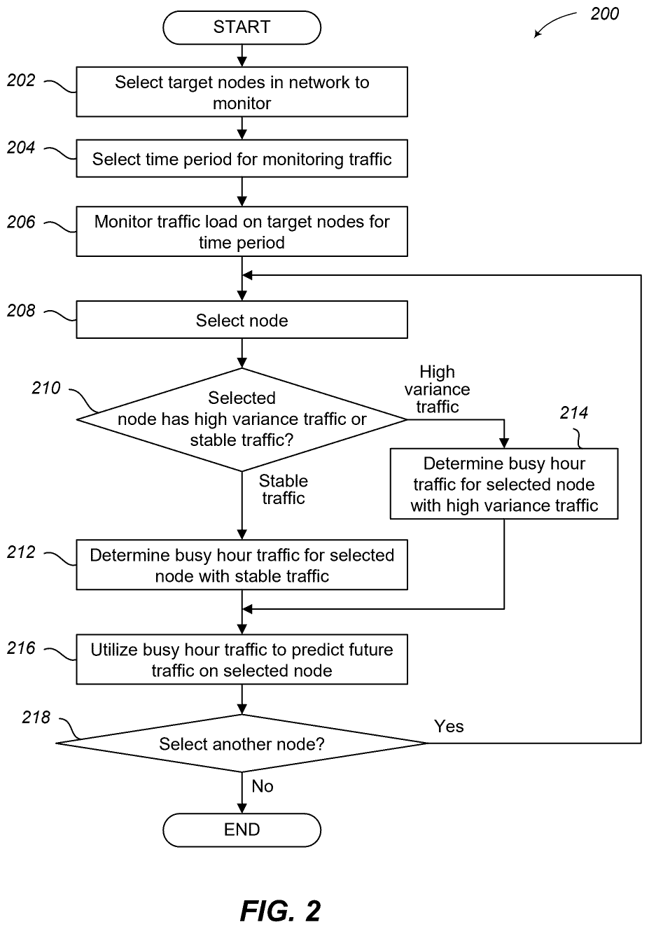

The operation of certain aspects will now be described with respect to FIGS. 2-4. In at least one of various embodiments, processes 200, 300, and 400 described in conjunction with FIGS. 2-4, respectively, may be implemented by or executed via circuitry or on one or more computing devices, such as node-busy-hour-determination computing system 102 in FIG. 1.

FIG. 2 illustrates a logical flow diagram showing one embodiment of a process 200 for dynamically determining busy hour traffic of a node in a cellular network using a mechanism selected based on the traffic load on the node in accordance with embodiments described herein.

Process 200 beings, after a start block, at block 202, where one or more target nodes in a cellular communications network are selected for monitoring. The target nodes may be selected by a user, an administrator, or pre-defined.

As noted above, nodes may be DUs, CUs, sectors, cells, RUs, or other components of a cellular network. Accordingly, the selected one or more nodes may be a specific type of node (e.g., all DUs or all CUs, etc.) or a combination of different node types (e.g., DUs and CUs). In various embodiments, the one or more target nodes may be selected based on the geography or market that they support (e.g., all DUs that support cellular communications in the Denver metropolitan area, but not DUs that support cellular communications outside of the Denver metropolitan area). Other criteria or combinations of criteria may also be used to select the one or more target nodes. For example, a plurality of cells for a specific sector and the RUs, DUs, and CUs supporting those cells may be selected as target nodes, while not selecting other cells for other sectors.

Process 200 proceeds, after block 202, to block 204, where a time period is selected for monitoring traffic on the target nodes. The time period may be selected by a user, an administrator, or pre-defined. The selected time period may be 30 days, 60 days, 6 months, or some other time period consisting of multiple days. In this way, the traffic on the target nodes can be monitored for multiple days. In some embodiments, the selected time period may be for consecutives days, e.g., 60 consecutive days. In other embodiments, the selected time period may be for specific days of the week, e.g., 60 consecutive Saturdays (but does not include Sunday through Friday).

Process 200 continues, after block 204, at block 206, where the traffic load on the target nodes is monitored for the selected time period. The traffic load is monitored, collected, or obtained for each target node multiple times per day during the selected time period. For example, the system may obtain the traffic load on each target node once per hour segment per day for the duration of the time period, with each separate traffic load being a data point. Assuming the time period is 60 days, the system obtains 24 data points each day for 60 days, which equals 1440 total data points of traffic load for the duration of the time period. Because one data point is obtained each hour segment each day during the time period, the system obtains 60 data points of traffic load for each separate hourly segment (e.g., 60 data points for the time segment from 1:00 am to 2:00 am; 60 separate data points for the time segment from 2:00 am to 3:00 am; etc.) for each separate target node.

In some embodiments, the system may monitor the traffic load on the target nodes by sending periodic requests (e.g., once during each hourly time segment) to the nodes such that each node reports the current load on that node. In other embodiments, the system may periodically receive traffic load updates (e.g., once per hourly time segment) from the target nodes, such as heartbeat or status updates.

Process 200 proceeds, after block 206, to block 208, where a specific node is selected from the monitored target nodes for further processing. In some embodiments, each node is individually selected in a defined order for further processing.

Process 200 continues, after block 208, at decision block 210, where a determination is made whether the traffic on the selected node is high variance traffic or is stable traffic during the monitoring time period. Nodes with high variance traffic tend to have low traffic loads a large percentage of the time with extreme high traffic loads relative to the low traffic loads for a very small percentage of time. In comparison, nodes with stable traffic tend to have relatively consistent traffic loads a large percentage of the time with no extreme high traffic loads. In various embodiments, the system may determine whether the traffic on the selected node is high variance traffic or is stable traffic based on a comparison of the traffic on the selected node against one or more criteria.

In some embodiments, high variance traffic may be defined as a statistical variance of the traffic load that is above a threshold value or above a threshold difference from the traffic of other nodes. And stable traffic may be defined as a statistical variance that is below a threshold value or below a threshold difference from the traffic of other nodes. In some embodiments, the variance may be calculated per day during the time period, such that the variance is averaged across the time period. In this way, a node with an average variance above the threshold value for the time period may be identified as a high variance traffic node, and a node with an average variance below the threshold value for the time period may be identified as a stable traffic node.

In other embodiments, high variance traffic may be defined as an amount of traffic (e.g., a daily amount of traffic that is averaged across the time period) that is below a threshold amount of traffic, which can be referred to as low-capacity traffic. Thus, a node with high variance traffic may be referred to as a low-capacity node. And stable traffic may be defined as an amount of traffic that is above the threshold amount of traffic, which can be referred to as high-capacity traffic. Thus, a node with stable traffic may be referred to as a high-capacity node.

If the monitored traffic load on the selected node is high variance traffic, then process 200 flows to block 214; but if the monitored traffic load on the selected node is stable traffic, then process 200 flows to block 212.

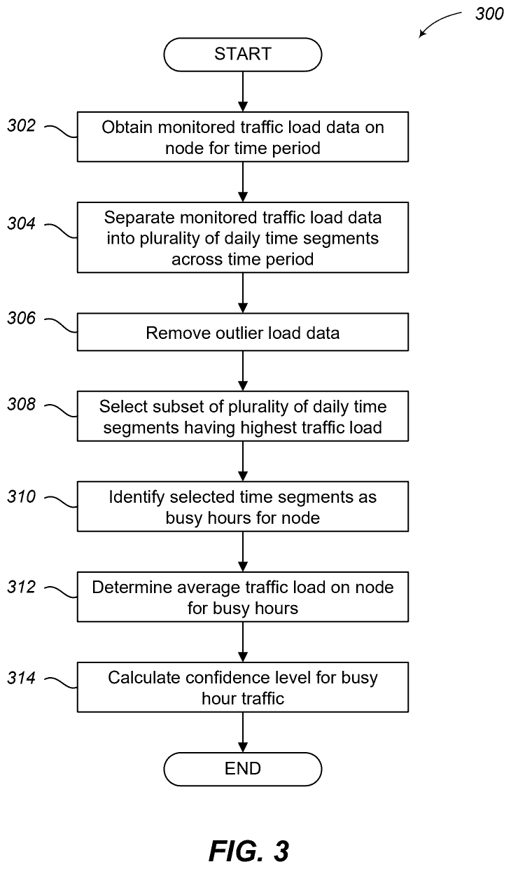

At block 212, busy hour traffic is determined for the selected node with stable traffic, which is described in more detail below in conjunction with FIG. 3. Briefly, however, the busy hour traffic is determined based on an average peak traffic load on the selected node.

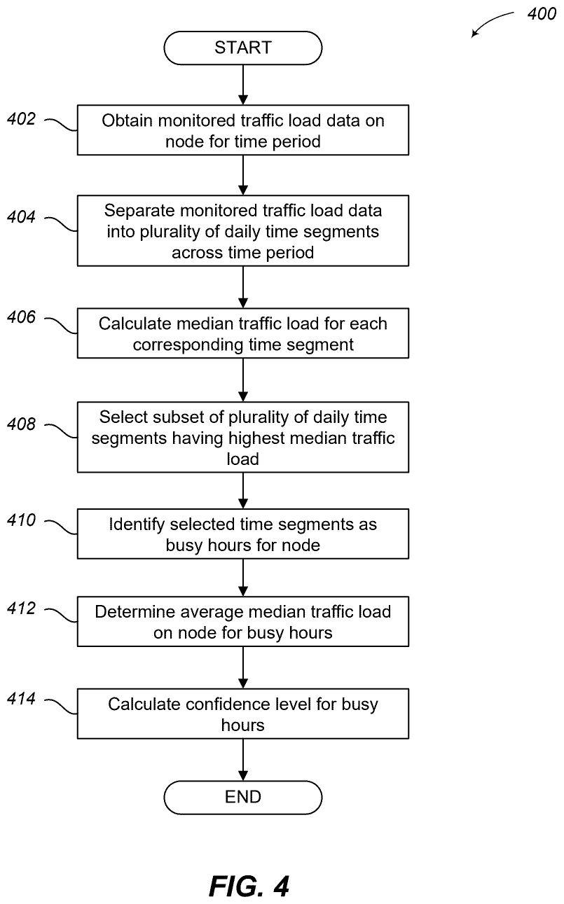

At block 214, busy hour traffic is determined for the selected node with high variance traffic, which is described in more detail below in conjunction with FIG. 4. Briefly, however, the busy hour traffic is determined based on an average median traffic load on the selected node.

After block 212 and after block 214, process 200 proceeds to block 216, where the busy hour traffic is used to predict future traffic on the selected node. In some embodiments, additional traffic is monitored on the node during second time period. The additional traffic can then be compared to the busy hour traffic. If the comparison between the additional traffic on the node and the busy hour traffic exceeds a load threshold for the node, then another node can be added to the cellular network. In this way, nodes can be scaled up (or scaled down) if the load on the node continues to increase over the busy hour traffic.

In some embodiments, the busy hour traffic can be compared against historical data (e.g., busy hour traffic determined for the node during a previous time period) or benchmarks to detect trends, patterns, or changes in the traffic load on the node. In this way, the number and use of nodes can be adjusted to balance between cellular network resource utilization and cellular user/customer experience.

Process 200 proceeds, after block 216, to decision block 218, where a determination is made whether another node is selected. In various embodiments, each target node selected and monitored may be selected in an ordered manner for further processing. If another target node has not yet been selected, then process 200 loops to block 208 to select another node. If all target nodes have been selected, then process 200 terminates or otherwise returns to a calling process to perform other actions.

FIG. 3 illustrates a logical flow diagram showing one embodiment of a process 300 for dynamically determining busy hour traffic of a node in a cellular network based on the traffic load on the node being stable in accordance with embodiments described herein.

Process 300 begins, after a start block, at block 302, where monitored traffic load data is obtained for a node for a time period. In various embodiments, the obtained traffic load is the traffic load monitored at block 206 in FIG. 2.

Process 300 proceeds, after block 302, to block 304, where monitored traffic load data is separated into a plurality of daily time segments across the time period. In various embodiments, each daily time segment is a one-hour time segment. For example, a first segment may be from 12:00 am to 1:00 am, a second segment may be from 1:00 am to 2:00 am, etc. The monitored traffic load data from each corresponding time segment is aggregated. As such, the traffic load data from 12:00 am to 1:00 am on day 1 is aggregated with the traffic load data from 12:00 am to 1:00 am on day 2 and so on, and the traffic load data from 1:00 am to 2:00 am on day 1 is aggregated with the traffic load data from 1:00 am to 2:00 am on day 2 and so on. In this way, each daily time segment is an aggregation of traffic load data for the same time segment from each day in the monitored time period.

Process 300 continues, after block 304, at block 306, where outlier load data is removed or discarded from each corresponding time segment. In some embodiments, the outlier load data for a corresponding time segment may be defined as any traffic load data for that corresponding time segment that is greater than 75th percentile for that corresponding time segment plus a select variable (e.g., 1.5) times the interquartile range for that corresponding time segment. The interquartile range for the corresponding time segment may be calculated as the range between the 25th percentile and the 75th percentile centered at the median traffic load for that corresponding time segment (where the median for the corresponding time segment is the mid-point of the traffic load data such that half of the traffic load data for the corresponding time segment is greater than or equal to the median and half is less than the median). The select variable that is multiplied by the interquartile range may be 1.5 or some other number selected by a user or an administrator.

Process 300 proceeds, after block 306, to block 308, where a subset of highest traffic load segments are selected from the plurality of daily time segments. In at least one embodiment, the three daily time segments that have the highest single traffic load data point (i.e., the maximum or peak monitored traffic load on three different day during the daily time segment) are selected as the subset. Although embodiments described herein use three daily time segments as having the highest traffic loads, embodiments are not so limited. In some embodiments, the subset of highest traffic load segments may be selected from the plurality of daily time segments as the three segments having the highest average traffic loads. Moreover, in other embodiments, two or four daily time segments (or other numbers of daily time segments) having the highest traffic load data may be selected.

Process 300 continues, after block 308, at block 310, where the selected subset of daily time segments are identified as being the busy hours for the node.

Process 300 proceeds, after block 310, to block 312, where an average traffic load is determined for the node from the traffic load data of the busy hours. In some embodiments, the highest traffic load from each busy hour is selected and averaged together, resulting in the average traffic load for the node. This average traffic load is the busy hour traffic for the node.

In one non-limiting example illustration, three busy hours are identified for the node as the three daily hour segments that have the highest traffic load values. Those highest traffic load values are summed together and then divided by three to result in the busy hour traffic (or average traffic load) for the node.

Process 300 continues, after block 312, at block 314, where a confidence level is calculated for the busy hour traffic. In some embodiments, the confidence level is a statistical significance of the busy hour traffic. For example, confidence intervals are calculated around the busy hours using one or more statistical significance methods, such as a statistical t-test. The results can help determine whether the observed busy hours (or observed busy hour traffic) are significantly different from the expected busy hours (or expected busy hour traffic) and can be useful for identifying nodes of the cellular network that may be at risk of congestion or capacity issues.

After block 314, process 300 terminates or otherwise returns to a calling process to perform other actions.

FIG. 4 illustrates a logical flow diagram showing one embodiment of a process 400 for dynamically determining busy hour traffic of a node in a cellular network based on the traffic load on the node having high variability in accordance with embodiments described herein.

Process 400 begins, after a start block, at block 402, where monitored traffic load data is obtained for a node for a time period. In various embodiments, the obtained traffic load is the traffic load monitored at block 206 in FIG. 2.

Process 400 proceeds, after block 402, to block 404, where monitored traffic load data is separated into a plurality of daily time segments across the time period. In various embodiments, block 404 may employ embodiments of block 304 in FIG. 3 to separate the traffic load data into a plurality of daily time segments.

Process 400 continues, after block 404, at block 406, where the median traffic load is calculated for each corresponding time segment. In some embodiments, the median or middle traffic load value is determined for each corresponding time segment.

Process 400 proceeds, after block 406, to block 408, where a subset of highest median traffic load segments are selected from the plurality of daily time segments. In at least one embodiment, the three daily time segments that have the highest median traffic load data point (i.e., the median monitored traffic load on a particular day during the daily time segment) are selected as the subset. Although embodiments described herein use three daily time segments as having the highest median traffic loads, embodiments are not so limited. In other embodiments, two or four daily time segments (or other numbers daily time segments) having the highest median traffic load data may be selected.

Process 400 continues, after block 408, at block 410, where the selected subset of daily time segments are identified as being the busy hours for the node.

Process 400 proceeds, after block 410, to block 412, where an average median traffic load is determined for the node from the median traffic load data of the busy hours. In some embodiments, the median traffic load from each busy hour is selected and averaged together, resulting in the average median traffic load for the node. This average median traffic load is the busy hour traffic for the node.

In one non-limiting example illustration, three busy hours are identified for the node as the three daily hour segments that have the highest median traffic load values. Those highest median traffic load values are summed together and then divided by three to result in the busy hour traffic (or average median traffic load) for the node.

Process 400 continues, after block 412, at block 414, where a confidence level is calculated for the busy hour traffic. In various embodiments, block 414 may employ embodiments of block 314 in FIG. 3 to determine the confidence level for the busy hour traffic for the node.

After block 414, process 400 terminates or otherwise returns to a calling process to perform other actions.

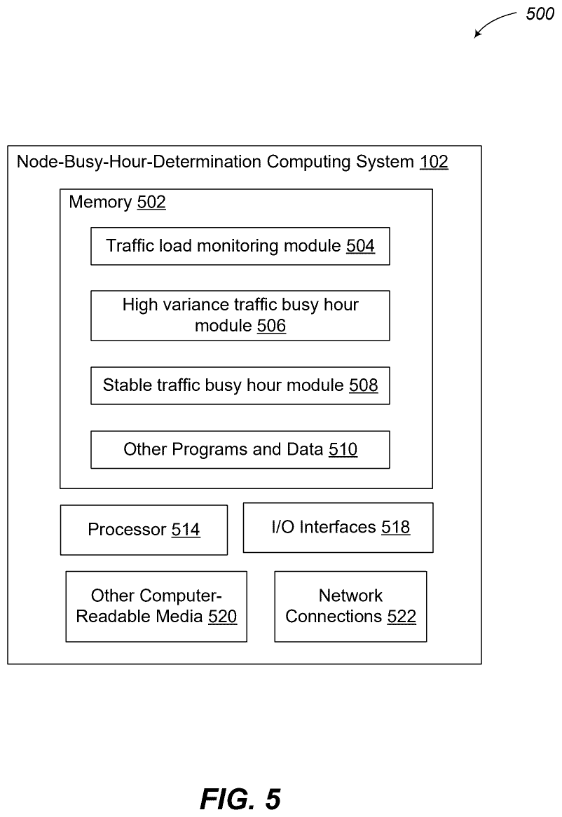

FIG. 5 shows a system diagram that describe various implementations of computing systems for implementing embodiments described herein. System 500 includes a node-busy-hour-determination computing system 102, similar to what is shown in FIG. 1.

The node-busy-hour-determination computing system 102 is a computing system or environment that determines busy hour traffic of nodes in a cellular communication network by employing different mechanisms based on whether the node is experiencing stable traffic or high variance traffic, as described herein. One or more special-purpose computing systems may be used to implement the node-busy-hour-determination computing system 102. Accordingly, various embodiments described herein may be implemented in software, hardware, firmware, or in some combination thereof. The node-busy-hour-determination computing system 102 includes memory 502, processor 514, I/O interfaces 518, other computer-readable media 520, and network connections 522.

Processor 514 includes one or more processors, one or more processing units, programmable logic, circuitry, or one or more other computing components that are configured to perform embodiments described herein or to execute computer instructions to perform embodiments described herein. In some embodiments, a processor system of the node-busy-hour-determination computing system 102 may include a single processor 514 that operates individually to perform actions. In other embodiments, a processor system of the node-busy-hour-determination computing system 102 may include a plurality of processors 514 that operate to collectively perform actions, such that one or more processors 514 may operate to perform some, but not all, of such actions. Reference herein to “a processor system” of the node-busy-hour-determination computing system 102 refers to one or more processors 514 that individually or collectively perform actions. And reference herein to “the processor system” of the node-busy-hour-determination computing system 102 refers to I) a subset or all of the one or more processors 514 comprised by “a processor system” of the node-busy-hour-determination computing system 102 and 2) any combination of the one or more processors 514 comprised by “a processor system” of the node-busy-hour-determination computing system 102 and one or more other processors 514.

Memory 502 may include one or more various types of non-volatile and/or volatile storage technologies. Examples of memory 502 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 502 may be utilized to store information, including computer-readable instructions that are utilized by processor 514 to perform actions, including embodiments described herein.

Memory 502 may have stored thereon a traffic load monitoring module 504, a high variance traffic busy hour module 506, and a stable traffic busy hour module 508. The traffic load monitoring module 504 is configured to monitor, collect, or obtain traffic load data from one node or a plurality of nodes over a select time period, as described herein. The high variance traffic busy hour module 506 is configured to calculate the busy hour traffic of a high variance traffic node based on the average median traffic loads of busy hours, as described herein (e.g., by performing process 400 in FIG. 4). And the stable traffic busy hour module 508 is configured to calculate the busy hour traffic of a stable traffic node based on the average highest traffic loads of busy hours, as described herein (e.g., by performing process 300 in FIG. 3). Although the traffic load monitoring module 504, the high variance traffic busy hour module 506, and the stable traffic busy hour module 508 are illustrated as separate modules, embodiments are not so limited. Rather, one module or a plurality of modules may be utilized to employ the functionality of the traffic load monitoring module 504, the high variance traffic busy hour module 506, and the stable traffic busy hour module 508.

Memory 502 may also have stored thereon the other programs and data 510, such as historical busy hour traffic data for one or more nodes.

Network connections 522 are configured to communicate with other computing devices. In various embodiments, the network connections 522 include transmitters and receivers (not illustrated) to send and receive data as described herein, such as to request or obtain traffic data from nodes. I/O interfaces 518 may include one or more data input or output interfaces, video or display interfaces, or other input/output interfaces. Other computer-readable media 520 may include other types of stationary or removable computer-readable media, such as removable flash drives, external hard drives, or the like.

The following is a summarization of the claims as originally filed.

A method may be summarized as comprising: selecting a node in a cellular network to monitor; selecting a time period for monitoring a traffic load on the node; monitoring the traffic load on the node during the time period; determining if the monitored traffic load on the node during the time period is stable traffic or high variance traffic; in response to the monitored traffic load on the node being stable traffic, determining busy hour traffic for the node based on an average peak traffic load on the node; in response to the monitored traffic load on the node being high variance traffic, determining the busy hour traffic for the node based on an average median traffic load on the node; and utilizing the busy hour traffic for the node to predict future traffic on the node.

The method may determine the busy hour traffic for the node based on the average peak traffic load in response to the monitored traffic load on the node being stable traffic by: separating the monitored traffic load into plurality of daily time segments across the time period; selecting a subset of daily time segments from the plurality of daily time segments having a highest traffic load; and identifying the selected subset of daily time segments as busy hours for the node.

The method may determine the busy hour traffic for the node based on the average peak traffic load in response to the monitored traffic load on the node being stable traffic by: separating the monitored traffic load into plurality of daily time segments across the time period; selecting a subset of daily time segments from the plurality of daily time segments having a highest traffic load; and determining the average peak traffic load for the node from an average of the traffic load from the selected subset of daily time segments.

The method may determine the busy hour traffic for the node based on the average peak traffic load in response to the monitored traffic load on the node being stable traffic by: determining a confidence level for the busy hour traffic.

The method may determine the busy hour traffic for the node based on the average median traffic load in response to the monitored traffic load on the node being high variance traffic by: separating the monitored traffic load into plurality of daily time segments across the time period; determining a median traffic load for each of the plurality of daily time segments; selecting a subset of daily time segments from the plurality of daily time segments having a highest median traffic load; and identifying the selected subset of daily time segments as busy hours for the node.

The method may determine the busy hour traffic for the node based on the average median traffic load in response to the monitored traffic load on the node being high variance traffic by: separating the monitored traffic load into plurality of daily time segments across the time period; determining a median traffic load for each of the plurality of daily time segments; selecting a subset of daily time segments from the plurality of daily time segments having a highest median traffic load; and determining the average median traffic load for the node from an average of the median traffic load from the selected subset of daily time segments.

The method may determine the busy hour traffic for the node based on the average median traffic load in response to the monitored traffic load on the node being high variance traffic by: determining a confidence level for the busy hour traffic.

The method may determine if the monitored traffic load on the node during the time period is stable traffic or high variance traffic by: determining an average traffic load across the time period from the monitored traffic load; determining that the monitored traffic load on the node is stable traffic in response to the average traffic load being above a threshold load; and determining that the monitored traffic load on the node is high variance traffic in response to the average traffic load being below threshold load.

The method may determine if the monitored traffic load on the node during the time period is stable traffic or high variance traffic by: determining, from the monitored traffic load, a total amount of traffic on the node during the time period; determining that the monitored traffic load on the node is stable traffic in response to the total amount of traffic on the node being above a threshold value; and determining that the monitored traffic load on the node is high variance traffic in response to the total amount of traffic on the node being below threshold value.

The method may utilize the busy hour traffic for the node to predict future traffic on the node by: monitoring additional traffic on the node during second time period; comparing the additional traffic on the node to the busy hour traffic; and in response to the comparison between the additional traffic on the node and the busy hour traffic exceeding load threshold for the node, adding another node to the cellular network.

The method may select the node in the cellular network to monitor by: selecting a distributed unit from a plurality of distributed units utilized by the cellular network, wherein the plurality of distributed units provide real-time support for lower layers of a protocol stack for cellular communications across the cellular network.

The method may select the node in the cellular network to monitor by: selecting a central unit from a plurality of central units utilized by the cellular network, wherein the plurality of central units provide real-time support for higher layers of a protocol stack for cellular communications across the cellular network.

The method may select the node in the cellular network to monitor by: selecting a sector in which one or more cells provide access to the cellular network.

The method may select the node in the cellular network to monitor by: selecting a cell of the cellular network.

The method may select the node in the cellular network to monitor by: selecting a radio unit of the cellular network.

A computing device may be summarized as comprising: a memory configured to store computer instructions; and a processor system configured to execute the computer instructions to: monitor a traffic load on a node in a wireless network during a time period; determine if the traffic load on the node during the time period is stable traffic or high variance traffic; in response to the traffic load on the node being stable traffic, determine busy hour traffic for the node based on an average peak traffic load on the node; in response to the traffic load on the node being high variance traffic, determine the busy hour traffic for the node based on an average median traffic load on the node; and utilize the busy hour traffic for the node to track future traffic on the node.

The processor system of the computing device may determine the busy hour traffic for the node based on the average peak traffic load in response to the traffic load on the node being stable traffic by further executing the computer instructions to: separate the traffic load into plurality of daily time segments across the time period; select a subset of daily time segments from the plurality of daily time segments having a highest traffic load; identify the selected subset of daily time segments busy hours for the node; and determine the average peak traffic load for the node from an average of the traffic load from the busy hours.

The processor system of the computing device may determine the busy hour traffic for the node based on the average median traffic load in response to the traffic load on the node being high variance traffic by further executing the computer instructions to: separate the traffic load into plurality of daily time segments across the time period; determine a median traffic load for each of the plurality of daily time segments; select a subset of daily time segments from the plurality of daily time segments having a highest median traffic load; identify the selected subset of daily time segments as busy hours; and determine the average median traffic load for the node from an average of the median traffic load from the busy hours.

The processor system of the computing device may further execute the computer instructions to: select the node from a plurality of distributed units utilized by the wireless network, a plurality of central units utilized by the wireless network, a plurality of sectors serviced by the wireless network, a plurality of cells of the wireless network, and a plurality of radio unit of the wireless network.

A non-transitory computer-readable storage medium may be summarized as storing instructions that, when executed by a processor in a computing system, cause the processor to perform actions, the actions comprising: monitoring traffic load on node in a cellular communications network during a time period; determining whether the node is a high-capacity node or a low-capacity node based on the traffic load of the node; in response to the node being a high-capacity node, determining busy hour traffic for the node based on an average peak traffic load on the node for the time period; in response to the node being a low-capacity node, determining the busy hour traffic for the node based on an average median traffic load on the node for the time period; and utilizing the busy hour traffic for the node to analyze future traffic on the node.

The various embodiments described above can be combined to provide further embodiments. All of the U.S. patents, U.S. patent application publications, and U.S. patent applications referred to in this specification are incorporated herein by reference, in their entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
selecting a node in a cellular network to monitor;
selecting a time period for monitoring a traffic load on the node;
monitoring the traffic load on the node during the time period;
determining if the monitored traffic load on the node during the time period is stable traffic or high variance traffic;
in response to the monitored traffic load on the node being stable traffic, determining busy hour traffic for the node based on an average peak traffic load on the node;
in response to the monitored traffic load on the node being high variance traffic, determining the busy hour traffic for the node based on an average median traffic load on the node; and
utilizing the busy hour traffic for the node to predict future traffic on the node.

2. The method of claim 1, wherein determining the busy hour traffic for the node based on the average peak traffic load in response to the monitored traffic load on the node being stable traffic comprises:
separating the monitored traffic load into plurality of daily time segments across the time period;
selecting a subset of daily time segments from the plurality of daily time segments having a highest traffic load; and
identifying the selected subset of daily time segments as busy hours for the node.

3. The method of claim 1, wherein determining the busy hour traffic for the node based on the average peak traffic load in response to the monitored traffic load on the node being stable traffic comprises:
separating the monitored traffic load into plurality of daily time segments across the time period;
selecting a subset of daily time segments from the plurality of daily time segments having a highest traffic load; and
determining the average peak traffic load for the node from an average of the traffic load from the selected subset of daily time segments.

4. The method of claim 1, wherein determining the busy hour traffic for the node based on the average peak traffic load in response to the monitored traffic load on the node being stable traffic comprises:
determining a confidence level for the busy hour traffic.

5. The method of claim 1, wherein determining the busy hour for the node based on the average median traffic load in response to the monitored traffic load on the node being high variance traffic comprises:
separating the monitored traffic load into plurality of daily time segments across the time period;
determining a median traffic load for each of the plurality of daily time segments;
selecting a subset of daily time segments from the plurality of daily time segments having a highest median traffic load; and
identifying the selected subset of daily time segments as busy hours for the node.

6. The method of claim 1, wherein determining the busy hour traffic for the node based on the average median traffic load in response to the monitored traffic load on the node being high variance traffic comprises:
separating the monitored traffic load into plurality of daily time segments across the time period;
determining a median traffic load for each of the plurality of daily time segments;
selecting a subset of daily time segments from the plurality of daily time segments having a highest median traffic load; and
determining the average median traffic load for the node from an average of the median traffic load from the selected subset of daily time segments.

7. The method of claim 1, wherein determining the busy hour traffic for the node based on the average median traffic load in response to the monitored traffic load on the node being high variance traffic comprises:
determining a confidence level for the busy hour traffic.

8. The method of claim 1, wherein determining if the monitored traffic load on the node during the time period is stable traffic or high variance traffic comprises:
determining an average traffic load across the time period from the monitored traffic load;
determining that the monitored traffic load on the node is stable traffic in response to the average traffic load being above a threshold load; and
determining that the monitored traffic load on the node is high variance traffic in response to the average traffic load being below threshold load.

9. The method of claim 1, wherein determining if the monitored traffic load on the node during the time period is stable traffic or high variance traffic comprises:
determining, from the monitored traffic load, a total amount of traffic on the node during the time period;
determining that the monitored traffic load on the node is stable traffic in response to the total amount of traffic on the node being above a threshold value; and
determining that the monitored traffic load on the node is high variance traffic in response to the total amount of traffic on the node being below threshold value.

10. The method of claim 1, wherein utilizing the busy hour traffic for the node to predict future traffic on the node comprises:
monitoring additional traffic on the node during second time period;
comparing the additional traffic on the node to the busy hour traffic; and
in response to the comparison between the additional traffic on the node and the busy hour traffic exceeding load threshold for the node, adding another node to the cellular network.

11. The method of claim 1, wherein selecting the node in the cellular network to monitor comprises:
selecting a distributed unit from a plurality of distributed units utilized by the cellular network, wherein the plurality of distributed units provide real-time support for lower layers of a protocol stack for cellular communications across the cellular network.

12. The method of claim 1, wherein selecting the node in the cellular network to monitor comprises:
selecting a central unit from a plurality of central units utilized by the cellular network, wherein the plurality of central units provide real-time support for higher layers of a protocol stack for cellular communications across the cellular network.

13. The method of claim 1, wherein selecting the node in the cellular network to monitor comprises:
selecting a sector in which one or more cells provide access to the cellular network.

14. The method of claim 1, wherein selecting the node in the cellular network to monitor comprises:
selecting a cell of the cellular network.

15. The method of claim 1, wherein selecting the node in the cellular network to monitor comprises:
selecting a radio unit of the cellular network.

16. A computing device, comprising:
a memory configured to store computer instructions; and
a processor system configured to execute the computer instructions to:
monitor a traffic load on a node in a wireless network during a time period;
determine if the traffic load on the node during the time period is stable traffic or high variance traffic;
in response to the traffic load on the node being stable traffic, determine busy hour traffic for the node based on an average peak traffic load on the node;
in response to the traffic load on the node being high variance traffic, determine the busy hour traffic for the node based on an average median traffic load on the node; and
utilize the busy hour traffic for the node to track future traffic on the node.

17. The computing device of claim 16, wherein the processor system determines the busy hour traffic for the node based on the average peak traffic load in response to the traffic load on the node being stable traffic by further executing the computer instructions to:
separate the traffic load into plurality of daily time segments across the time period;
select a subset of daily time segments from the plurality of daily time segments having a highest traffic load;
identify the selected subset of daily time segments as busy hours; and
determine the average peak traffic load for the node from an average of the traffic load from the busy hours.

18. The computing device of claim 16, wherein the processor system determines the busy hour traffic for the node based on the average median traffic load in response to the traffic load on the node being high variance traffic by further executing the computer instructions to:
separate the traffic load into plurality of daily time segments across the time period;
determine a median traffic load for each of the plurality of daily time segments;
select a subset of daily time segments from the plurality of daily time segments having a highest median traffic load;
identify the selected subset of daily time segments as busy hours; and
determine the average median traffic load for the node from an average of the median traffic load from the busy hours.

19. The computing device of claim 16, wherein the processor system further executes the computer instructions to:
select the node from a plurality of distributed units utilized by the wireless network, a plurality of central units utilized by the wireless network, a plurality of sectors serviced by the wireless network, a plurality of cells of the wireless network, and a plurality of radio unit of the wireless network.

20. A non-transitory computer-readable storage medium that stores instructions that, when executed by a processor in a computing system, cause the processor to perform actions, the actions comprising:
monitoring traffic load on node in a cellular communications network during a time period;
determining whether the node is a high-capacity node or a low-capacity node based on the traffic load of the node;
in response to the node being a high-capacity node, determining busy hour traffic for the node based on an average peak traffic load on the node for the time period;
in response to the node being a low-capacity node, determining the busy hour traffic for the node based on an average median traffic load on the node for the time period; and
utilizing the busy hour traffic for the node to analyze future traffic on the node.
